(19) United States
(12) Patent Application Publication
(10) Pub. No.: US 2006/0190441 A1
(43) Pub. Date: Aug. 24, 2006

(54) Search toolbar

(76) Inventors: William Gross, Pasadena, CA (US); Lee Z. Hasiuk, Rochester, NY (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/349,032

(22) Filed: Feb. 7, 2006

Related U.S. Application Data
(60) Provisional application No. 60/650,772, filed on Feb. 7, 2005.

(51) Int. Cl. G06F 17/30

(52) U.S. Cl. 707/3

(57) ABSTRACT

A toolbar apparatus includes program code stored in computer readable memory. The program code is configured display a control panel listing a plurality of information sources. At least one of the information sources is accessed via a computer network, and at least one is not. The program code is further configured to record a user selection associated with a quantity of selected information sources from the plurality of information sources. The program code is further configured to display, in a toolbar, a quantity of data entry fields that is equal to the quantity of selected information sources. Each of the data entry fields is associated with a selected information source. The program code is further configured to receive a search query entered into a data entry field. The program code is further configured to submit the search query to the selected information source associated with the data entry field.

### CROSS-REFERENCE TO RELATED APPLICATIONS

This application claims the benefit of U.S. Provisional Patent Application 60/650,772, filed on 7 Feb. 2005, the entire disclosure of which is hereby incorporated by reference herein.

### FIELD OF THE INVENTION

The present invention relates generally to systems and methods for using a graphical user interface to provide commands to a computer, and relates more specifically to systems and methods for using a toolbar to access data and implement functions associated with a wide variety of different computer program modules.

### BACKGROUND OF THE INVENTION

Modern computer software systems typically employ a graphical user interface to convey information to and receive commands from users. Graphical user interfaces often comprise a variety of visual elements, such as icons, text, drop-down menus, dialogue boxes, toolbars, buttons, and the like. A user interacts with the graphical user interface by using a pointing device, such as a mouse, to position a cursor over a visual element and select the element. An example of a computer operating system that employs a graphical user interface is the Windows® family of operating systems, which are manufactured and sold by Microsoft Corporation (Redmond, Wash.).

A common graphical user interface visual element that is used to efficiently display computer commands is the toolbar. In many toolbars, commands are represented by buttons, menus, dialogue boxes and/or other controls. A user invokes a command by selecting a button, choosing a menu option, or entering information into a dialogue box. Toolbars are often visually attached to an “application window”, which is a window in which the primary viewing and/or editing interaction occurs for an application program. However, toolbars are also often configured to float above, below, or to the side of an application window. In many application programs that use toolbars, the toolbars are often user-customizable, thereby enabling a user to modify the toolbar appearance, position and elements so as to streamline access to commonly-used commands.

### BRIEF SUMMARY OF THE INVENTION

Among the many applications for which toolbars have been developed are Internet browsers. For example, toolbars have been developed to allow users to quickly submit search queries to an Internet search engine. Such “search toolbars” generally include a dialogue box into which a user enters a search query. Typically, upon submission of the query the Internet browser is configured to display a webpage listing search results, thus allowing the user to bypass the initial step of pointing the browser to the search engine homepage to submit the query. While conventional search toolbars are useful in this respect, they often still suffer from several disadvantages, such as an inability to simultaneously submit a query to multiple search engines, and an inability to search for and implement functions that are not associated with Internet search engines. Disclosed herein is an improved search toolbar, certain embodiments of which address these and other disadvantages.

In one embodiment of the present invention, a toolbar apparatus includes program code stored in computer readable memory. The program code is configured to display a control panel listing a plurality of information sources. At least one of the information sources is accessed via a computer network, and at least one is not. The program code is further configured to record a user selection associated with a quantity of selected information sources from the plurality of information sources. The program code is further configured to display, in a toolbar, a quantity of data entry fields that is based on the quantity of selected information sources. Each of the data entry fields is associated with a selected information source. The program code is further configured to receive a search query entered into a data entry field. The program code is further configured to submit the search query to the selected information source associated with the data entry field.

In another embodiment of the present invention, a method for providing a search interface comprises displaying a search toolbar including a plurality of dialogue boxes that include a text entry field label positioned within the dialogue box. The search toolbar is configured to hover over, and is not associated with, an application window or a system menu bar.

In another embodiment of the present invention, a method for providing a search system interface comprises displaying a toolbar having a plurality of search fields. The method further comprises submitting a sample query to a website having search functionality, thereby transmitting to the website a plurality of HTTP packets containing the sample query. The method further comprises analyzing the plurality of HTTP packets to determine an HTTP POST syntax used by the website to receive a search query. The method further comprises adding a new search field to the toolbar. The new search field is configured to submit a search query entered therein to the website using the HTTP POST syntax, thereby causing the website the generate search results based on the search query.

In another embodiment of the present invention, a method for providing a search system interface comprises displaying a toolbar having a plurality of dialogue boxes. The method further comprises submitting a sample query to a website having search functionality, thereby causing the website to generate a webpage listing search results based on the sample query. The webpage has a uniform resource locator. The method further comprises analyzing the uniform resource locator to determine a syntax used by the website to generate search results. The method further comprises adding a new dialog box to the toolbar. The new dialogue box is configured to submit a search query entered therein to the website using the syntax, thereby causing the website to generate search results based on the search query.

In another embodiment of the present invention, a search apparatus comprises a toolbar that is not associated with an application window or a system menu bar. The toolbar includes a plurality of search interfaces that are displayed simultaneously with each other, including (a) a website search interface having an associated website search dialogue box and a website search history list, and (b) a local search interface having an associated local search dialogue box and a local search history list. The search apparatus further comprises a computer configured to incrementally search a search history list as characters are entered into a search interface corresponding to the search history list. The computer is further configured to submit a search query entered into the website search dialogue box to a website associated with the website search dialogue box. The website is accessed via a computer network. The computer is further configured to perform a search on a local storage device based on a search query entered into the local search dialogue box. The local storage device forms a part of the computer.

In another embodiment of the present invention, a toolbar application includes program code stored on a computer in computer readable memory. The program code is configured to display a control panel listing a plurality of user selectable information sources. The program code is further configured to at least partially cause a toolbar to be added to a user interface of an application. The application is distributed separately from the toolbar application. The toolbar includes (a) a quantity of search dialogue fields that is based on a quantity of information sources selected by the user in the control panel, wherein each of the search dialogue fields corresponds to one of the quantity of information sources selected by the user in the control panel, and (b) a preferences menu though which the control panel is accessible. The program code is further configured to cause a search to be performed on an information source using a term entered into the corresponding search dialogue field.

In another embodiment of the present invention, a toolbar apparatus includes program code stored in computer readable memory. The program code is configured to at least partially cause a toolbar to be displayed on a user terminal. The toolbar includes a dialogue field associated with a control panel that includes a plurality of user selectable search engines. The program code is further configured to determine whether a text entered into the dialogue field is a search term or a command. If the text entered in the dialogue field is not a command, the program code is further configured to cause the text to be transmitted to a search engine selected by the user from the control panel. If the text entered in the dialogue field is a command, the program code is further configured to cause the command to be executed.

### BRIEF DESCRIPTION OF THE DRAWINGS

Example embodiments are illustrated in the accompanying drawings, which are for illustrative purposes only. The drawings comprise the following figures, in which like numerals indicate like parts.

FIG. 1 is a schematic illustration of selected example components of a computer system usable with certain of the search toolbar embodiments disclosed herein.

FIG. 2 is a photograph of an example embodiment of a search toolbar in a partially collapsed state.

FIG. 3 is a photograph of an example embodiment of the search toolbar of FIG. 2 in a deployed expanded state.

FIG. 4 is a photograph of an example embodiment of the search toolbar of FIG. 3 showing a list of locally-accessed search results.

FIG. 5 is a depiction of an example embodiment of the search toolbar of FIG. 3 accompanied by a list of remotely-accessed search results.

FIG. 6 is a flowchart illustrating an example method of using certain of the search toolbars disclosed herein.

FIG. 7 is a flowchart illustrating an example method of using a wizard to add dialogue boxes to the search toolbars disclosed herein.

### DETAILED DESCRIPTION OF PREFERRED EMBODIMENTS

Embodiments of the present invention provide systems and methods for using a user interface, such as a toolbar, to access data and the functions of a wide variety of computer program modules.

As will be described in greater detail herein, in one example embodiment a search toolbar provides multiple dialogue boxes corresponding to different information sources that are to be searched. The information sources include both information sources that are remotely accessed via a computer network (such as websites and Internet search engines), as well as information sources that are locally accessed on a user's computer (such as a “Favorites” folder or a list of applications).

In the following description, the term “website” is used to refer to a user-accessible server site that implements the basic Word Wide Web standards for the coding and transmission of hypertext documents. These standards currently include the hypertext markup language (“HTML”) and the hypertext transfer protocol (“HTTP”). Additionally, while certain embodiments are described as being implemented using Java script, also referred to as JavaScript, other types of script, programming languages, and code are used to implement other embodiments. The terms “site” and “website” do not imply a single geographic location, as a web or other network site is generally capable of including multiple geographically distributed computer systems that are appropriately linked together. Furthermore, while the following description relates to an embodiment using the Internet and related protocols, other networks, such as interactive television networks or cellular phone networks, and other protocols are used in alternative embodiments.

Additionally, unless otherwise indicated, the functions described herein are performed by executable code and instructions running on one or more general-purpose computers. However, alterative embodiments are implemented using special purpose computers, state machines, and/or hardwired electronic circuits. The example processes described herein do not necessarily have to be performed in the described sequence, and not all states have to be reached or performed.

The description provided herein refers to “clicking on” or “selecting” a link or button, or pressing a key to provide a command or make a selection. However, the commands or selections are optionally or alternatively made using other input techniques, such as using voice input, pen input, mousing or hovering over an input area, and the like. Further, while certain example user interfaces will refer to a “toolbar,” the present invention is not limited to a toolbar, and other user interfaces and configurations, such as a circular-shaped, triangular-shaped, an irregularly shaped, or a changing shape user interface can be used as well.

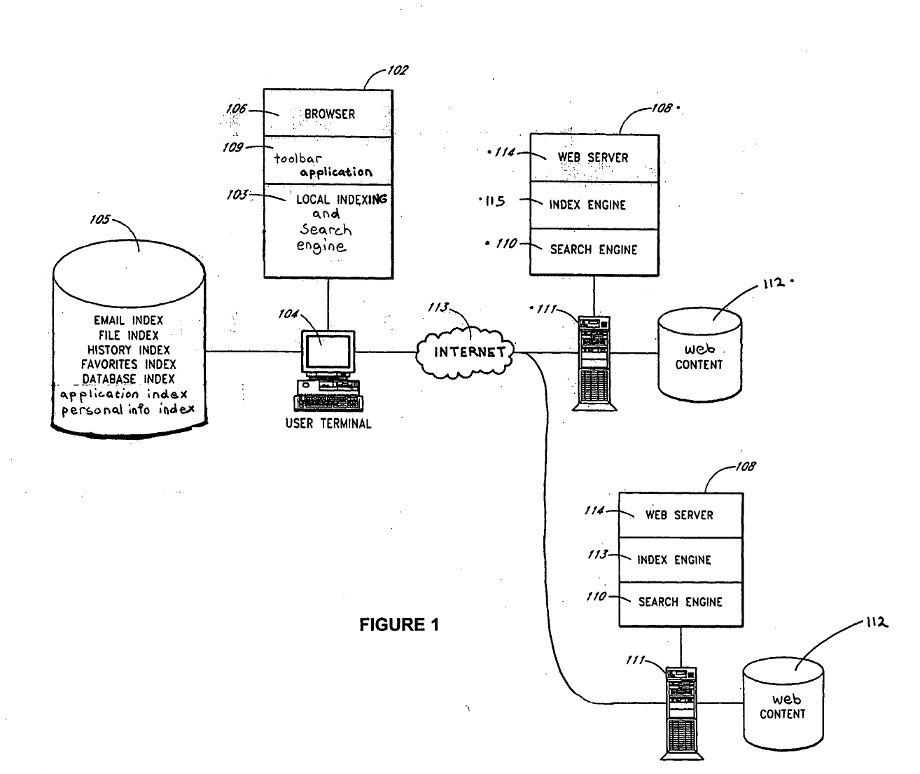

FIG. 1 illustrates selected example hardware and software components on a physical and/or functional level that are usable with certain of the search toolbar embodiments disclosed herein. The illustrated embodiment includes software 102 that is stored on and executed by a user terminal 104. The software 102 includes a toolbar application 109 that is capable of controlling the display and operation of a search toolbar, as described in greater detail herein. The software 102 also optionally includes other components, such as a web browser application 106 and a local indexing and searching application 103. Example web browser applications 106 include Microsoft Internet Explorer® which is available from Microsoft Corporation (Redmond, Wash.), and Netscape Navigator® which is available from Netscape Communications Corporation (Mountain View, Calif.). An example indexing and searching application is X1®, which is available from X1 Technologies (Pasadena, Calif.). Optionally, other applications, such as, by way of example, an email client, calendaring software, instant messaging software, an electronic address book, and spreadsheet software, can be hosted as well.

In an example embodiment, the user terminal 104 is a personal computer, although in other embodiments the user terminal 104 is another device, such as an interactive television, a networkable programmable digital assistant, a computer networkable wireless phone, or another similar device. The user terminal 104 optionally has access to the Internet via a network interface. The user terminal 104 is associated with one or more user interface or peripheral devices, such as a display, a keyboard, a mouse, a trackball, an electronic pen, a microphone, a speaker, a printer and a storage device. Example storage devices include semiconductor, magnetic and optical storage devices.

The toolbar application 109 is downloadable or accessible from a remote website; is loaded via removable, optical, magnetic or semiconductor memory; is preloaded on a storage device associated with the user terminal 104; or is otherwise stored and/or made accessible to the user terminal 104.

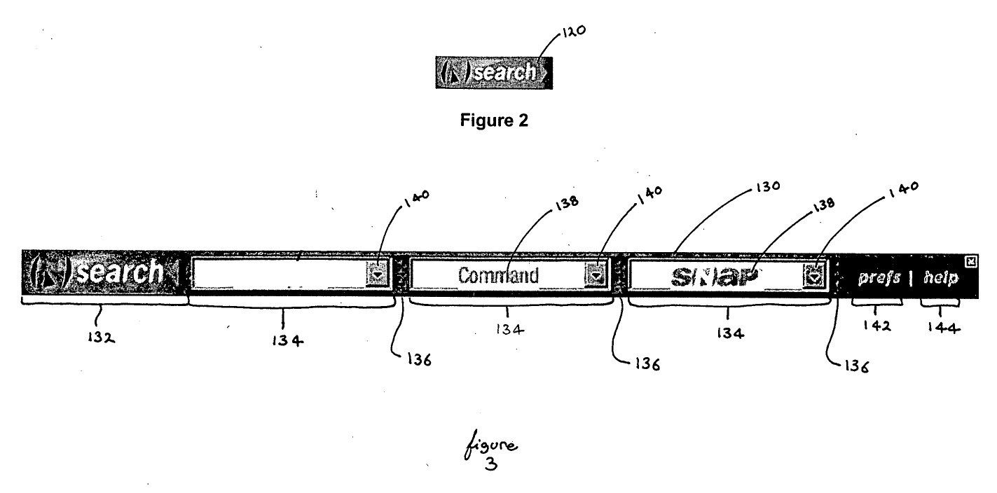

The toolbar application 109 is configured to display a dynamic search toolbar on a display associated with the user terminal 104. FIG. 2 is a depiction of a partially collapsed search toolbar 120. As illustrated, the partially collapsed search toolbar 120 occupies a relatively small area, which advantageously leaves a relatively large portion of the display available for other uses. In a modified embodiment, the partially collapsed search toolbar 120 is capable of “auto-hiding” when not being used, meaning that the toolbar partially or completely moves off of one side of the display, thereby further making the display area available for other uses. In such embodiments, the toolbar is restored to its partially collapsed state by moving the cursor to a designated edge of the display.

In an example embodiment, selecting the partially collapsed search toolbar 120 causes the toolbar to display in a deployed state. In such embodiments, the partially collapsed search toolbar 120 is selected using a pointing device or using a user-definable keyboard hotkey combination, such as CTRL+1 or [symbol] +2. FIG. 3 is a photograph of a deployed search toolbar 130. The deployed search toolbar 130 includes an icon region 132, wherein selecting the icon region 132 causes the search toolbar to return to the partially collapsed state. The deployed search toolbar 130 further includes one or more dialogue boxes 134 configured for text entry, wherein each dialogue box 134 is optionally associated with an adjacent grabber 136. The grabber 136 enables the relative position of the dialogue boxes 134 to be adjusted by “dragging and dropping” the grabber associated with a selected dialogue box that is to be repositioned. The dialogue boxes 134 include optional text entry field labels 138 and optional dropdown history list activators 140. The deployed search toolbar also optionally includes one or more menus, such as a preferences menu 142 and a help menu 144.

Optionally, the partially collapsed search toolbar 120 and the deployed search toolbar are advantageously independent of other applications executed by the user terminal 104. For example, in such embodiments the toolbars are not associated with application windows or system menu bars, such as the “Start Menu” bar commonly used in Windows®-based operating systems. This allows the toolbars to operate independently from other applications, and to remain accessible when such other applications are closed or busy. In other embodiments, the search toolbar is docked in an application window, but preferably consumes less than about 60% of the application window area, more preferably less than about 80% of the application window area, and most preferably less than about 85% of the application window area.

A dialogue box 134 is associated with an information source that is capable of being searched. As used herein, the term “information source” includes both information sources that are remotely accessed via a computer network (such as websites and Internet search engines), as well as information sources that are locally accessed on a user's computer (such as a “Favorites” folder or a list of applications). The term “information source” also includes executable resources, such as applications that are invoked locally or remotely. Thus, applications used to print documents or generate emails are examples of information sources.

FIG. 1 illustrates a user terminal 104 that is connected to a local content index 105 corresponding to data stored in the user terminal 104. In an example embodiment, the local content index 105 includes one or more content indices stored on the user terminal 104, such as an electronic mail index, a data file index, an Internet browsing history index, a Start Menu index, a control panel index, a favorites index, a database index, an application index, and a personal information index (including items such as contact and calendar information). The local content index 105 is optionally generated by the indexing and searching application 103, which is configured to scan and index data stored in storage devices associated with the user terminal 104. In certain embodiments the indexing and searching application 103 is configured to generate a composite index of different content types stored in various content locations. In other embodiments the indexing and searching application 103 is configured to generate multiple content indices that are segregated by content type or storage location.

FIG. 1 also illustrates that the user terminal 104 is connected via the Internet 113 to one or more computer systems 111 that host websites 108. The websites 108 include web server applications 114, such as commercially-available web server applications, that are configured to access databases used to generate webpages in response to queries from end users. For example, the web server applications 114 are capable of responding to a request for a webpage from the web browser application 106, and delivering the generated webpage to the web browser application 106 via the Internet 113.

In an example embodiment, the website 108 includes content that spans multiple Internet domains, and is optionally implemented using physical servers that are geographically remote from one another. In other embodiments, the website 108 is in the form of an intranet site, in which case the user terminal 104 is connected to the website 108 via a private network instead of the Internet 113. For example, in one embodiment the website 108 is in the form of an internal corporate store site for company employees. In still other embodiments, the website 108 is replaced with another type of network site. Specifically, the various services described herein are optionally implemented on a hypertext site or browsing area of an online services network such as America Online® or MSN®, and a user optionally accesses the site using software that implements nonstandard document formats and transfer protocols.

Still referring to FIG. 1, the website 108 also includes an index engine 115 and a search engine 110 which are configured to execute on the computer system 111. The computer system 111 includes a content database 112, which stores the full text of one or more of the webpages that comprise website 108. Once a webpage is stored in the content database 112, the webpage is then indexed by the index engine 115. The indexing process includes webpage text, links and other content. The resulting index is stored in or in association with the content database 112. When a user submits a query or search terms to the remote search engine 110, the remote search engine 110 searches the index based on the query or search terms, including Boolean terms. The search engine 110 locates appropriate search results, and links to the corresponding webpages are transmitted to the user terminal 104 for display. While the remote search engine 110 and the index engine 115 are indicated as separate entities in FIG. 1, in other embodiments they are combined in a single engine or module.

The functionality of the website 108 and remote search engine 110 are accessible to the toolbar application 109 via the Internet 113. This allows a user to submit a search query to the remote search engine 110 by entering the query terms into one of the search toolbar dialogue boxes 134. In an example embodiment, a plurality of dialogue boxes 134 are provided for the plurality of remote search engines 110, such that a user can select the search engine to which a query is to be submitted by entering the query in an appropriate dialogue box 134. The optional text entry field label 138 is used to provide the user with a visual indication of which remote search engine 110 corresponds to which dialogue box 134. In a modified embodiment, a “composite” dialogue box is provided, wherein a query entered in the composite dialogue box is submitted to a plurality of the remote search engines 110. In another modified embodiment, each of the dialogue boxes 134 is associated with a single information source.

In similar fashion, a plurality of dialogue boxes 134 are provided for the plurality of different types of content that are stored in the local content index 105. For example, in one such embodiment separate dialogue boxes 134 are associated with content types such as email, instant messages, Microsoft Word® documents, text documents, HTML documents, spreadsheet documents, favorites, Internet browsing history, multimedia, music, video, podcasts, applications, and personal information (such as address book and calendar information). Thus, a user can select which type of content is to be searched by entering search terms in the appropriate dialogue box 134. The optional text entry field label 138 is used to provide the user with a visual indication of which content type corresponds to which dialogue box 134. In a modified embodiment, a composite dialogue box is provided, wherein a plurality of the data types are searched using terms entered into the composite dialogue box.

In an example embodiment, the quantity of dialogue boxes 134 displayed in the toolbar, and the information sources associated with the displayed dialogue boxes 134 are user-configurable. For instance, in one embodiment a control panel is accessible via the preferences menu 142, whereby the user configures the number of dialogue boxes displayed and the information sources associated with the displayed dialogue boxes. In certain embodiments the displayed dialogue boxes are automatically provided with equal sizes, while in other embodiments the user is able to adjust the relative size, orientation and other appearance characteristics of the displayed dialogue boxes. For example, the grabbers 136 are used in certain applications to both move and re-size the displayed dialogue boxes.

The remote search engines 110 correspond to websites 108 that have searching functionality included therein. Such websites include search engines, as well as a wide variety of other websites, such as newspaper websites, electronic commerce websites, entertainment websites, reference websites, and other websites that generate a listing of search results based on a search query entered by a user.

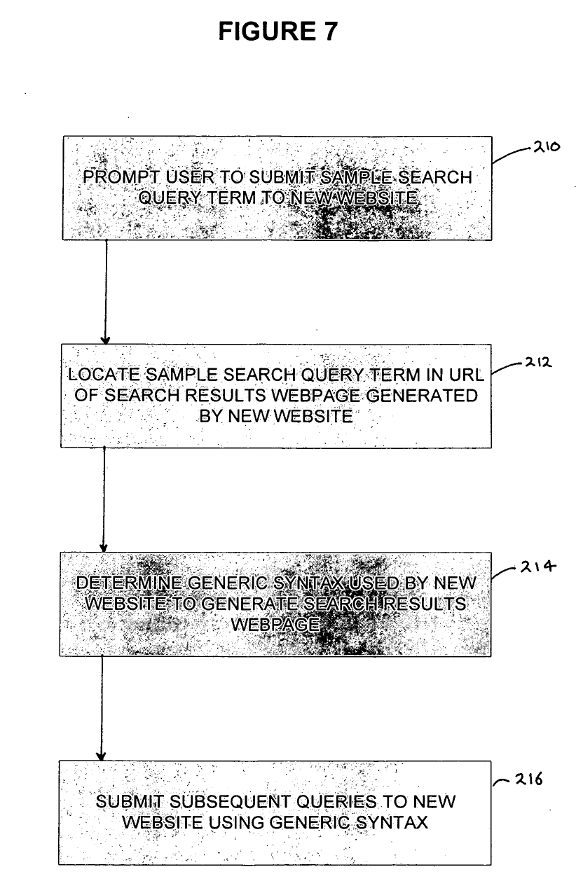

In one embodiment, the preferences menu 142 allows the user to access a wizard that facilitates the process of adding a dialogue box 134 to the search toolbar that corresponds to a new website. FIG. 7 is a flowchart illustrating an example method used by the wizard in this process. In an operational block 210, the wizard prompts the user to execute a search on the new website. In an operational block 212, the wizard analyzes the uniform resource locator (“URL”) of the webpage generated by the new website in response to the search query. By locating the search query in the URL, the wizard determines the URL syntax used by the new website to generate search results generally, as indicated by operational block 214. Thus the toolbar can subsequently submit a search query that is entered into one of the dialogue boxes 134 to the new website, and display the search results generated by the new website, as indicated by operational block 216.

For example, if a user wishes to add a dialogue box associated with the new website http://www.latimes.com, the wizard will direct the user to execute a search on this website. If the user conducts a search on the new website using the query “baseball”, the website generates a webpage listing search results relating to that query. The URL of the webpage with such search results is http://www.latimes.com/search/dispatcher.front?Query=baseball&target=article. The wizard analyzes this URL by locating the search query term “baseball” therein. Based on this analysis, the wizard determines that, in general, a search query {Q} can be submitted to the new website by generating a URL http://www.latimes.com/search/dispatcher.front?Query={Q}&target=article. Once the wizard has determined this syntax by its analysis of the URL generated by the user's initial search, the toolbar is configured to submit future queries to the new website using the syntax.

Certain websites do not reflect search parameters using URL syntax, but instead accept form data in the transmitted HTTP packet using the HTTP POST method. This method is particularly useful where the form data exceeds the maximum length allowed in a URL. However, even when the form data is transmitted in the HTTP packet, the search query is generally submitted using the same syntax as when it is submitted in a URL. Therefore, in certain embodiments the methods disclosed herein for generating a generalized URL syntax are also used to generate a generalized HTTP packet syntax. In such embodiments a module such as a packet sniffer, proxy server, layered service provide or other method of monitoring network traffic is used to examine the packets that are sent to a website when a search is conducted. Analyzing these packets allows the search query syntax to be determined in the same way that analyzing a URL allows search query syntax to be determined. Thus, certain embodiments of the toolbar are compatible with a wide variety of websites to which search queries are submitted.

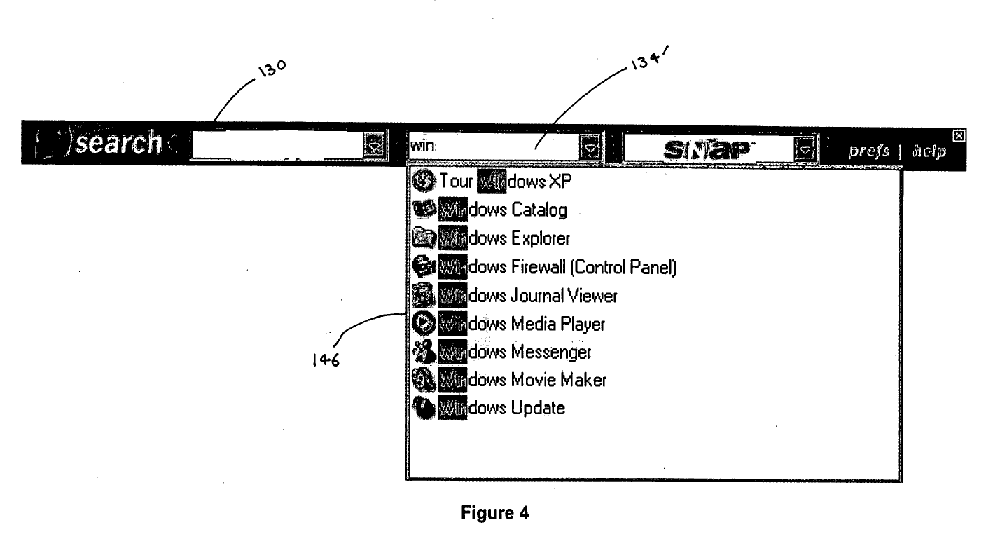

As described herein, one or more of the dialogue boxes 134 optionally include a history list stored in computer readable memory that is accessed using a dropdown history list activator 140. In such embodiments, selecting the dropdown history list activator 140 provides the user with a history list of searches that have been entered into the corresponding dialogue box 134. Optionally, the queries displayed in the history list are selectable, such that selecting a listed query causes the query text to be automatically entered into the dialogue box 134, thereby providing the user with a convenient way to resubmit a frequently used query. In certain embodiments, text in one dialogue box can be “dragged and dropped” or cut and pasted into another dialogue box. In certain embodiments, as text is entered into a dialogue box 134, an incremental search of the history list is performed. For example, FIG. 4 illustrates incremental search results 146 generated by typing “win” in to a selected dialogue box 134′.

Still referring to the example embodiment illustrated in FIG. 3, the deployed search toolbar optionally includes one or more selectable menus, such as a preferences menu 142 and a help menu 144. The preferences menu 142 provides access to tools used to modify the appearance, operation and features of the search toolbar, as described herein. The help menu 144 provides access to information regarding the operation of the search toolbar. Fewer or additional menus are provided in other embodiments.

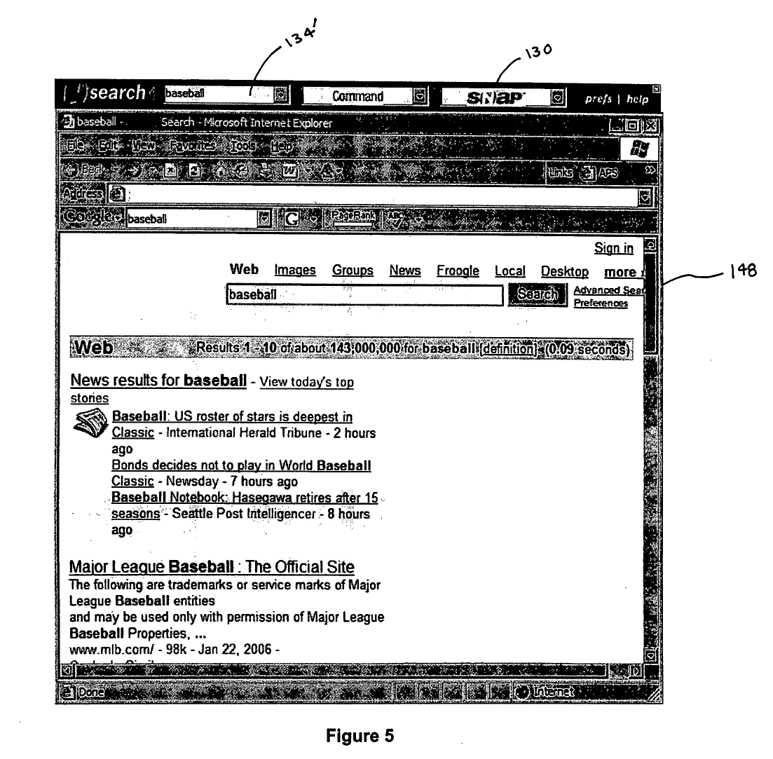

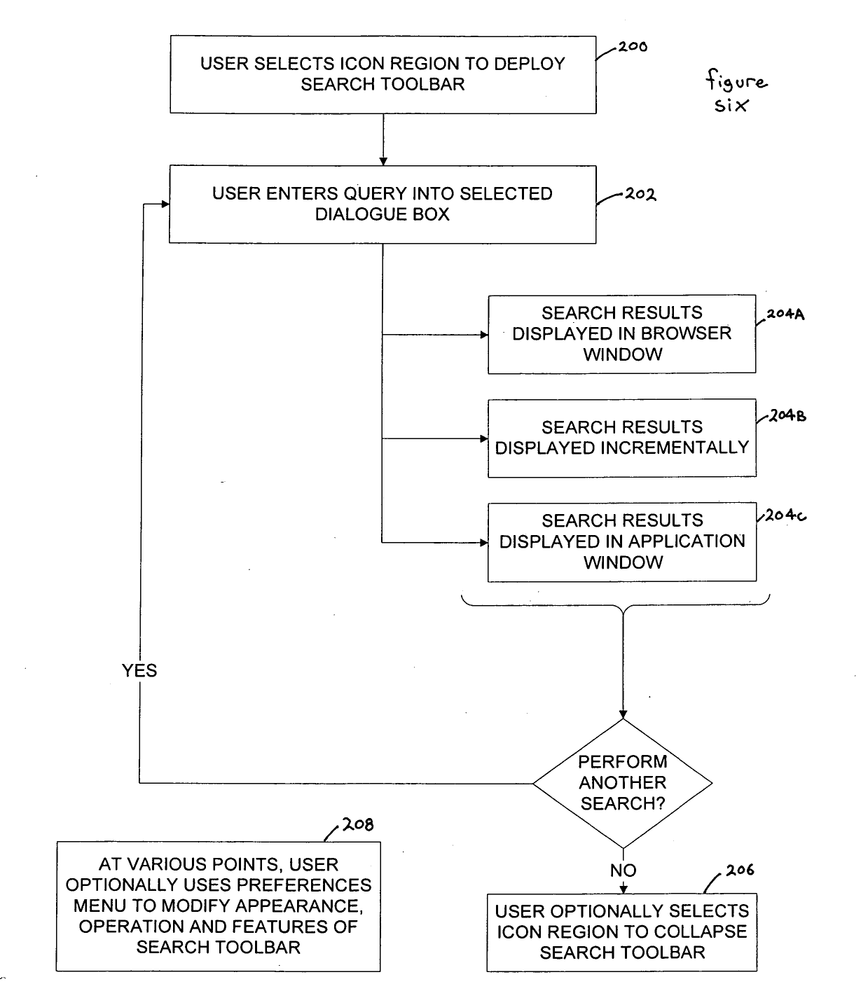

As expounded herein, entering a search query into a dialogue box 134 causes a search to be performed on an information source, such as the website 108 or the local content index 105. In certain embodiments, such as illustrated in FIG. 5, the search results are presented in a browser window 148 generated by the website 108 that generates the search results. In other embodiments, the search results are incrementally displayed adjacent to the search toolbar, as illustrated in FIG. 4. In embodiments wherein the search toolbar includes composite dialogue boxes, the search results are presented in a plurality of browser windows that each correspond to one of the information sources searched by the composite dialogue box.

In embodiments wherein a dialogue box 134 is configured to search a non-website-based information source, such as the email index, Internet browsing history index, the Start Menu index, the control panel index, the favorites index, the application index, or other index, the search results are displayed in a separate window adjacent to the deployed search toolbar 130, as illustrated in FIG. 4. In such embodiments, one of the search results can be selected and opened directly from the separate window. For example, in a search for an application named “Calculator”, the letters “calc” are typed into a dialogue box corresponding to the application index. A search is incrementally performed as the user enters the letters, and corresponding incremental search results are displayed, including the Calculator application. Selecting the Calculator application from the list of incremental search results automatically launches the Calculator application. By way of further example, the user can enter all or a portion of the word “Excel”, “Word”, “PowerPoint”, “Explorer”, “Windows Media Player”, “Firefox”, “Skype” or other application name, and the search engine will incrementally locate the corresponding application(s) and present them to the user. The user can then select the desired application from the search results, and the application will be launched. In another example, a contact list is incrementally searched from a dialogue box associated with a personal information index, and a selected contact identified in such a search is opened directly from a list of incremental search results 146. In embodiments wherein a dialogue box 134 is configured to search a non-website-based information source, the search toolbar is optionally configured to use a supplemental searching program to incrementally display search results based on characters typed into the dialogue box 134.

In certain embodiments, a natural language interpreter is used to analyze search queries entered into one or more selected dialogue boxes. In such embodiments, the natural language interpreter is configured to facilitate access to certain commands entered via the dialogue box. For example, entering a command/operator and an object, such as the command “print XYZ.doc”, causes the document XYZ.doc to be printed, thereby eliminating the need for the user to separately launch the appropriate application, open the particular file, and issue the print command. In this example, the command/operator and object are separated by a space, although other separators, such as one or more designated characters or icons, are used in other embodiments. In modified embodiments, entering the command “print document” triggers an incremental search for certain file types (such as word processor documents, spreadsheets, HTML pages, and other frequently-printed files) based on the characters that the user subsequently enters into the dialogue box.

Another example of a natural language command that is compatible with certain embodiments is “email John”, wherein a search is performed for “John” in the user's contact index, a list of the search results is presented to the user, and once the user selects a contact, an email is generated with the email address of the selected contact appearing in the “to” field. Other similar examples include “calendar (event)” to launch a “new appointment form”, or “call (name)” to initiate a VoIP call. In general, the natural language interpreter detects the entry of a command, and subsequently searches for files, contacts, email, or other data associated with the entered command. Optionally the search is an incremental search.

FIG. 6 is a flowchart illustrating an example method of using certain of the search toolbars disclosed herein. As illustrated in FIG. 6, a user selects the icon region 132 to deploy a partially collapsed search toolbar 130, as indicated by operational block 200. The user then enters a query into one or more selected dialogue boxes 134, as indicated by operational block 202. In one embodiment, the user selects which dialogue box 134 that text is to be entered into using a mouse or other pointing device. In other embodiments, the user selects which dialogue box 134 that text is to be entered into using a hotkey combination, such as CTRL+1 or [symbol] +2. In such embodiments, the hotkey combinations associated with the dialogue boxes 134 are adjustable using controls accessible via the preferences menu 142.

Depending on the information source searched, and the configuration of the search toolbar, the search results are displayed in a browser window (as indicated by operational block 204A), the search results are displayed incrementally such as illustrated in FIG. 4 (as indicated by operational block 204B), or the search results are displayed in an appropriate application and a selected search result is implemented from a listing of search results (as indicated by operational block 204C). Typically, search results generated by a website are displayed in a browser window, while search results generated from non-website-based information sources are displayed incrementally. However, in an example embodiment the particularly method used to display search results is user-definable, and is adjusted by operating a switch that is accessible through the preferences menu 142.

Still referring to FIG. 6, the user has the option to perform additional searches by submitting additional queries to a dialogue box 134, as indicated by operational block 202. However, if no further searches are to be performed, the user has the option to collapse the deployed search toolbar 130 so as to make a portion of the display available for other uses, as indicated by operational block 206.

As described herein, the preferences menu 142 is used to access controls for modifying the appearance, operation and/or features of the search toolbar. For example, in one embodiment the preferences menu is usable to adjust how many dialogue boxes 134 are displayed in a deployed toolbar, and to control which information sources are associated with the displayed dialogue boxes 134. In one embodiment the preferences menu includes a wizard configured to add dialogue boxes 134 that correspond to new websites 108. As indicated by operational block 208 in FIG. 6, the user selects the preferences menu at various points in the process of using the search toolbar.

Selected embodiments of the search toolbars disclosed herein address certain of the disadvantages of conventional search toolbars. For example, certain embodiments disclosed herein allow a user to simultaneously submit a query to multiple search engines using a composite dialogue box. Furthermore, use of multiple dialogue boxes advantageously eliminates the need to use syntactical commands to indicate which information source is to be searched. Additionally, certain embodiments disclosed herein allow a user to implement application functions directly from the toolbar, instead of, for example, navigating the conventional Start Menu hierarchy in a Windows®-based operating system. This eliminates the need for users to remember the particular location or subfolder in which a shortcut to a particular application is stored.

### SCOPE OF THE INVENTION

While the foregoing detailed description discloses several embodiments of the present invention, it should be understood that this disclosure is illustrative only and is not limiting of the present invention. It should be appreciated that the specific configurations and operations disclosed can differ from those described above, and that the methods described herein can be used in contexts other than search toolbars.

We claim:

1. A toolbar apparatus including program code stored in computer readable memory, the program code configured to:
display a control panel listing a plurality of information sources, wherein at least one of the information sources is accessed via a computer network, and at least one of the information sources is not accessed via a computer network;
record a user selection associated with a quantity of selected information sources from the plurality of information sources;
display, in a toolbar, a quantity of data entry fields that is based on the quantity of selected information sources, such that each of the data entry fields is associated with a selected information source;
receive a search query entered into a data entry field; and
submit the search query to the selected information source associated with the data entry field.

2. The toolbar apparatus of claim 1, wherein the control panel lists a plurality of information sources that are not accessed via a computer network, and wherein the plurality of information sources that are not accessed via a computer network are selected from the group consisting of an electronic mail index, and contacts index, a calendar index, a multimedia index, a file index, and a folder index.

3. The toolbar apparatus of claim 1, wherein the control panel is accessed using a preferences menu displayed on the toolbar.

4. The toolbar apparatus of claim 1, wherein each of the data entry fields is associated with one selected information source.

5. The toolbar apparatus of claim 1, wherein the toolbar has a shape selected from the group consisting of a triangular-shaped toolbar and a circular-shaped toolbar.

6. The toolbar apparatus of claim 1, wherein:
a data entry field is associated with a plurality of selected information sources; and
the program code is further configured to submit the search query to a plurality of selected information sources.

7. The toolbar apparatus of claim 1, wherein the program code is further configured to:
to display a plurality of grabbers, wherein each of the grabbers is associated with a data entry field;
reposition the data entry fields in the toolbar when the user performs a drag-and-drop operation using the grabber.

8. The toolbar apparatus of claim 1, wherein the program code is further configured to:
to display a plurality of grabbers, wherein each of the grabbers is associated with a data entry field;
resize the data entry fields in the toolbar when the user performs a select-and-drag operation using the grabber.

9. The toolbar apparatus of claim 1, wherein at least one of the data entry fields includes a field label positioned within the data entry field.

10. The toolbar apparatus of claim 1, wherein:
at least one of the data entry fields includes a field label positioned within the data entry field; and
the field label includes text and graphics.

11. The toolbar apparatus of claim 1, wherein the program code is further configured to display an information source history list associated with a selected data entry field, wherein typing characters into the selected data entry field incrementally searches the information source history list.

12. The toolbar apparatus of claim 1, wherein the program code is further configured to identify an operator and an object entered into a data entry field.

13. The toolbar apparatus of claim 1, wherein the program code is further configured to:
identify an operator and an object entered into a data entry field; and
execute a command corresponding to the operator, wherein the command is executed on the object entered into the data entry field.

14. A method for providing a search interface, the method comprising displaying a search toolbar including a plurality of dialogue boxes that include a text entry field label positioned within the dialogue box, wherein the search toolbar is configured to hover over, and is not associated with, an application window or a system menu bar.

15. The method of claim 14, further comprising collapsing the search toolbar in response to a user command.

16. The method of claim 14, further comprising hiding the search toolbar when an idle state is detected.

17. The method of claim 14, wherein the text entry field label includes text.

18. The method of claim 14, wherein the text entry field label includes text and graphics.

19. The method of claim 14, further comprising incrementally displaying selected items on a search history list in response to a user entering characters in a dialogue box associated with the search history list.

20. The method of claim 14, further comprising activating a selected dialogue box in response to a user command, wherein the user command is the pressing of a hotkey combination.

21. The method of claim 14, further comprising displaying a preferences menu in response to a user command, wherein the preferences menu provides a control for adjusting the number of dialogue boxes included in the search toolbar.

22. The method of claim 14, wherein the local content includes email, calendar items, multimedia items and contact information.

23. A method for providing a search system interface, the method comprising:
displaying a toolbar having a plurality of search fields;
submitting a sample query to a website having search functionality, thereby transmitting to the website a plurality of HTTP packets containing the sample query;
analyzing the plurality of HTTP packets to determine an HTTP POST syntax used by the website to receive a search query; and
adding a new search field to the toolbar, wherein the new search field is configured to submit a search query entered therein to the website using the HTTP POST syntax, thereby causing the website the generate search results based on the search query.

24. The method of claim 23, further comprising detecting the plurality of HTTP packets using a packet sniffer.

25. The method of claim 23, wherein the new search field is configured to submit a search query entered therein to the website using HTTP POST syntax generated by an operating system.

26. The method of claim 23, further comprising collapsing the toolbar in response to a user command.

27. The method of claim 23, wherein submitting the sample query comprises entering search terms into a search field appearing on the website.

28. A method for providing a search system interface, the method comprising:
displaying a toolbar having a plurality of dialogue boxes;
submitting a sample query to a website having search functionality, thereby causing the website to generate a webpage listing search results based on the sample query, wherein the webpage has a uniform resource locator;
analyzing the uniform resource locator to determine a syntax used by the website to generate search results; and
adding a new dialogue box to the toolbar, wherein the new dialogue box is configured to submit a search query entered therein to the website using the syntax, thereby causing the website to generate search results based on the search query.

29. The method of claim 28, further comprising collapsing the toolbar in response to a user command.

30. The method of claim 28, wherein the sample query is user-defined.

31. The method of claim 28, wherein submitting the sample query comprises entering search terms into a search box appearing on the website.

32. The method of claim 28, wherein analyzing the uniform resource locator comprises locating the sample query in the uniform resource locator.

33. The method of claim 28, wherein the syntax comprises a generalized uniform resource locator, wherein the generalized uniform resource locator is generated by:
locating the sample query in the uniform resource locator; and
replacing the sample query with a placeholder.

34. The method of claim 28, wherein:
the syntax comprises a generalized uniform resource locator, wherein the generalized uniform resource locator is generated by (a) locating the sample query in the uniform resource locator, and (b) replacing the sample query with a placeholder; and
the new dialogue box submits a search query entered therein to the website by replacing the placeholder with the search query in the generalized uniform resource locator.

35. A search apparatus, comprising:
a toolbar that is not associated with an application window or a system menu bar, the toolbar including a plurality of search interfaces that are displayed simultaneously with each other, including (a) a website search interface having an associated website search dialogue box and a website search history list, and (b) a local search interface having an associated local search dialogue box and a local search history list; and
a computer configured to:
incrementally search a search history list as characters are entered into a search interface corresponding to the search history list;
submit a search query entered into the website search dialogue box to a website associated with the website search dialogue box, wherein the website is accessed via a computer network; and
perform a search on a local storage device based on a search query entered into the local search dialogue box, wherein the local storage device forms a part of the computer.

36. The apparatus of claim 35, wherein the toolbar has a shape selected from the group consisting of a triangular-shaped toolbar and a circular-shaped toolbar.

37. The apparatus of claim 35, wherein the apparatus is further configured to execute an application found in the search on the local storage device.

38. The apparatus of claim 35, wherein the website search history list and the local search history list are accessible using dropdown history list activators.

39. The apparatus of claim 35, wherein the website associated with the website search dialogue box is a search engine website.

40. The apparatus of claim 35, wherein text in a first search interface can be moved to a second search interface using a “drag-and-drop” operation.

41. The apparatus of claim 35, wherein the local storage device is a hard disk.

42. The apparatus of claim 35, wherein the computer network is the Internet.

43. The apparatus of claim 35, wherein the apparatus is configured to submit a search query entered into the website search dialogue box to a plurality of websites that are accessed via the computer network.

44. A toolbar application including program code stored on a computer in computer readable memory, the program code configured to:
display a control panel listing a plurality of user selectable information sources;
at least partially cause a toolbar to be added to a user interface of an application, the application distributed separately from the toolbar application, wherein the toolbar includes
a quantity of search dialogue fields that is based on a quantity of information sources selected by the user in the control panel, wherein each of the search dialogue fields corresponds to one of the quantity of information sources selected by the user in the control panel, and
a preferences menu though which the control panel is accessible; and
cause a search to be performed on an information source using a term entered into the corresponding search dialogue field.

45. The toolbar apparatus of claim 44, wherein the control panel is accessible as a dropdown menu via the preferences menu.

46. The toolbar apparatus of claim 44, wherein the program code is further configured to display an information source history list associated with the first search dialogue field, wherein typing characters into the first search dialogue field incrementally searches the information source history list.

47. The toolbar apparatus of claim 44, wherein the first information source is accessed over a network, and the second information source is stored on the same computer as the toolbar apparatus.

48. The toolbar apparatus of claim 44, further comprising program code configured to:
determine whether text entered into at least one of the search dialogue fields includes a command; and
if the text includes a command, cause the command to be executed.

49. The toolbar apparatus of claim 48, wherein the command is a print command.

50. The toolbar apparatus of claim 48, wherein the command is a telephonic command.

51. The toolbar apparatus of claim 48, wherein the command is an email-related command.

52. The toolbar apparatus of claim 48, wherein the command is a calendar-related command.

53. The toolbar apparatus of claim 48, wherein the command is related to a word processor application.

54. The toolbar apparatus of claim 48, wherein the command is related to a media player application.

55. The toolbar apparatus of claim 44, further comprising program code configured to:
determine whether text entered into at least one of the search dialogue fields includes a command and an object; and
if the text includes a command and an object, cause the command to be executed using the object.

56. A toolbar apparatus including program code stored in computer readable memory, the program code configured to:
at least partially cause a toolbar to be displayed on a user terminal, wherein the toolbar includes a dialogue field associated with a control panel that includes a plurality of user selectable search engines;
determine whether a text entered into the dialogue field is a search term or a command;
if the text entered in the dialogue field is not a command, cause the text to be transmitted to a search engine selected by the user from the control panel; and
if the text entered in the dialogue field is a command, cause the command to be executed.

57. The toolbar apparatus of claim 56, wherein the program code is further configured to determine whether an object has been entered into the dialogue field in association with the text.

58. The toolbar apparatus of claim 56, wherein if the text is a command, the program code causes the command to operate on an object entered into the dialogue field.

59. The toolbar apparatus of claim 56, wherein the program code is further configured to cause a supplemental dialogue field to be included on the toolbar, wherein a query entered into the supplemental dialogue field is transmitted to a supplemental search engine selected by the user from the control panel.

60. The toolbar apparatus of claim 56, wherein the text includes a command in the form of a word processor application name, a spreadsheet application name, a database application name, or a browser name.
